(19) United States
(12) Patent Application Publication
(10) Pub. No.: US 2016/0355701 A1
(43) Pub. Date: Dec. 8, 2016

(54) MODIFIED ASPHALTIC PRODUCT AND PROCESS

(71) Applicants: Michael Des Jarlais, Yakima, WA (US); Karen S. Hyatt, Yakima, WA (US)

(72) Inventors: Michael Des Jarlais, Yakima, WA (US); Karen S. Hyatt, Yakima, WA (US)

(21) Appl. No.: 15/178,535

(22) Filed: Jun. 9, 2016

Related U.S. Application Data
(63) Continuation-in-part of application No. 13/434,698, filed on Mar. 29, 2012.
(60) Provisional application No. 61/516,207, filed on Mar. 30, 2011.

(51) Int. Cl. C09D 195/00

(52) U.S. Cl. CPC C09D 195/00

(57) ABSTRACT

An asphalt modifying binder product, which is essentially a cut-back bituminous binder, uniquely including a petroleum product, such as diesel fuel or alternatively an organic oil, including vegetable or animal derived fats or oils, or glycol, for use in the manufacture of cold-mix asphalt “CMA” and asphalt treated base products. When mixed with an dense-graded aggregate with fine aggregate fractions, a dense-graded and non-porous cold-mix asphaltic improved product is formulated. The improved product may be employed as a patching/paving material or an asphalt treated base, stays pliable for extended periods of time at an ambient temperature, and again meets the typical required specifications and standards, for stability, flow and voids, when tested as hot-mix asphalt or asphalt treated base.

This Non-Provisional application claims priority to Provisional Patent Application Ser. No. 61/516,207, filed Mar. 30, 2011, and Non-Provisional application Ser. No. 13/434,698, filed Mar. 29, 2012.

### TECHNICAL FIELD

The invention relates to a stable, pliable and ambient placed modified asphalt product, and a process for its manufacture. Specifically, the product includes a binder mixed with organic oils, tallows and/or glycerol, polymeric and paraffin adjuncts, along with ‘cut-back’ agents, additionally with the inclusion of an evenly graded aggregate that includes fine aggregate fractions, for a dense-graded and non-porous cold-mix asphaltic product.

### BACKGROUND OF THE INVENTION

Hot-mix asphalt or “HMA” is an engineered material, primarily used in road and parking areas for vehicles. In general, there are two ingredients to HMA: aggregates and liquid asphalt. Aggregates can be in the form of stone, gravel or sand. The selection of which single or combination of aggregates used in a given mixture of HMA, depends on the specifications needed and what is available, locally.

In general, aggregates represent approximately 95% of the total weight of an HMA product. The remaining 5% of HMA weight comprises a liquid asphalt, which is also referred to as ‘asphalt cement’ or ‘simply asphalt.’ Asphalt functions well as a waterproof, thermoplastic, and visco-elastic adhesive for the aggregate. Essentially, the asphalt functions as a glue, to hold the product together in use. For engineering specifications, as utilized by those persons skilled in HMA production, the American Society for Testing and Materials “ASTM D” defines an asphalt cement as a ‘fluxed’ or ‘unfluxed’ asphalt, specially prepared as to quality and consistency for direct use in the manufacture of ‘bituminous’ pavements, with bitumen defined as a class of black or dark-colored, solid or liquid cementitious substance, either natural or manufactured that is composed principally of high molecular weight hydrocarbons, of which tars, pitches, and ‘asphaltenes’ are typical constituents. Furthermore, a flux is generally defined as a bituminous material, typically liquid, that is used for softening other bituminous materials.

Cold-Mix Asphalt “CMA” is produced either by emulsifying the asphalt in water with a soap material prior to mixing the asphalt with the aggregate, or by adding a ‘cut-back’ material, as discussed below. While in its emulsified state, the asphalt is less viscous and the mixture and is relatively easy to work with and compact. The emulsion will break down after enough water evaporates and ideally, the CMA will take on the properties of cold HMA. CMA is commonly used as a patching material and on lesser trafficked roads and paths.

A ‘cut-back’ asphalt is generally known as a combination of asphalt cement and a petroleum solvent. Typically, cut-backs are employed because they reduce asphalt viscosity for lower temperature uses, such as re-sealing coats, tack coats, fog seals, slurry seals, and for stabilization materials. After the cut-back asphalt is applied or “laid-down,” the petroleum solvent evaporates leaving behind the asphalt cement residue upon the surface to which it was applied. The cut-back asphalt is said to ‘cure’ as the petroleum solvent evaporates away. Manufacturers and users of cutback asphalt products must be sensitive to increasingly stringent environmental regulations. The volatile chemicals of the cut-back solvents evaporate into the atmosphere, creating potential air emission issues. These volatiles also leach into the foundational or base aggregate, and run off into roadway shoulders and catch basins, which drain to streams or infiltrate into subsurface water.

Additionally, the petroleum solvents used in cut-backs typically require significant energy to manufacture and are expensive. Therefore, an alternative CMA product is needed that utilizes environmentally safe cut-back agents, being easily mixed and remaining viscous and usable for long periods under a wide range of temperature conditions.

Furthermore, in outdoor environments, water and moisture, especially when coupled with freezing temperatures, serve to damage and destroy asphaltic products and materials. In addition, the permeation of water into the base or bedding material causes a dispersement or displacement of the finer, sand-sized particles within the base material. This material displacement process is referred to as “hydraulic migration,” and this process is accelerated when an asphalt material overlaying the bedding material is porous. The migration of water through the asphalt material weakens the base material through hydraulic migration, and the asphalt product, which is flexible, sinks or otherwise degrades to the point of failure.

The cut-back binders used in conventional cold-mix asphaltic products are selected to provide the needed “workability” or pliability, when the product is placed or laid-down. These conventional cut-back binders virtually assure deformation, degradation and eventual failure of repaired areas, because they allow water to seep through to the overlaid, base material. An asphaltic product is needed that maintains its workability when used, while protecting the overlaid base material. Specifically, there is a need in the asphalt paving industry for cold-mix asphalt products with the ability to perform at hot-mix end-use specifications. These specification include the industry specified parameters for stability, strength, flow, resistance to deformation, and voids within the compacted product.

The following is a disclosure of the present invention that will be understood by reference to the following detailed description taken in conjunction with the accompanying drawings.

### BRIEF DESCRIPTION OF DRAWINGS

FIG. 1 is a schematic flow chart of a process for making a modified asphalt product, according to an embodiment of the invention;

FIG. 2 is a schematic flow chart of a process for making a modified asphalt product, according to an embodiment of the invention;

FIG. 3 is a schematic flow chart of a process for making a modified asphalt product, according to an embodiment of the invention;

FIG. 4 is a cross section of a ‘prior art,’ open-graded asphalt product; and

FIG. 5 is a cross section of a cold-mix dense-graded modified asphalt product, according to an embodiment of the invention.

Reference characters included in the above drawing indicate corresponding parts, as discussed herein. The description herein illustrates one preferred embodiment of the invention, in one form, and the description herein is not to be construed as limiting the scope of the invention in any manner. It should be understood that the above listed figures are not necessarily to scale and that the embodiments may be illustrated by fragmentary views, graphic symbols, diagrammatic or schematic representations, and phantom lines. Details that are not necessary for an understanding of the present invention by one skilled in the technology of the invention, or render other details difficult to perceive, may have been omitted.

### DETAILED DESCRIPTION OF SPECIFIC EMBODIMENTS

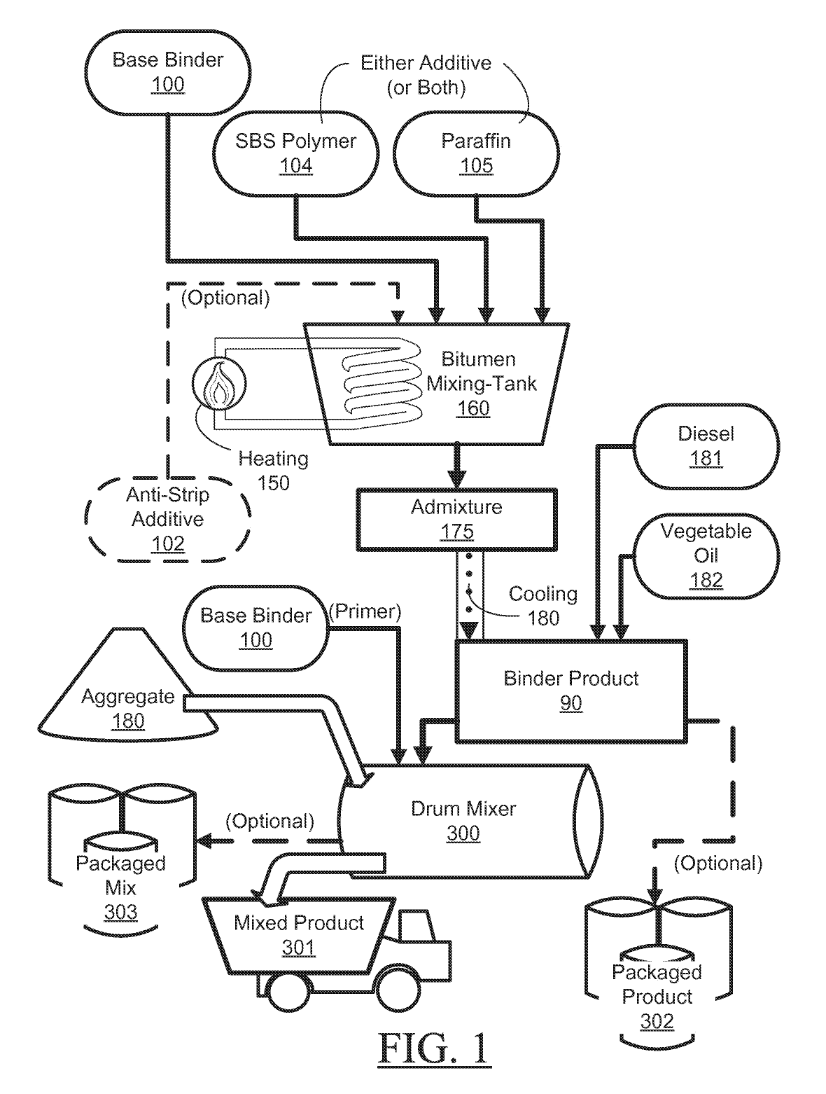

The invention provides an asphalt binder product, simply referred to herein as the “Product,” or “Binder Product” 90, as referenced in FIG. 1. The Binder Product is essentially a ‘cut-back’ bituminous binder, for use in the manufacture of Cold-Mix Asphalt “CMA” and asphalt treated base products. When mixed with an aggregate 180, the Product blends within the gradation ranges as typically specified by federal, state and local entities. As discussed further below, the Product may be employed as a patching/paving material or an asphalt treated base, either of which stays pliable for extended periods of time, measured in months or years, and again meets the typical required specifications and standards, for stability, flow and ‘voids total mix,’ when tested as hot-mix asphalt or asphalt treated base, in conformance with industry standard ‘Hveem’ or ‘Marshall Mix’ design methods.

Additionally, the present invention is directed to a process for preparing the asphalt Binder Product 90. Specifically, as shown in FIG. 1, the Product is produced by first heating a conventional and ‘regionally prescribed’ Base Binder 100, such as an ‘ASPHALT PG 64-22’ product, as manufactured by Paramount Petroleum of Paramount, Calif., or by Esso Imperial Oil of Ontario, Canada. The base binder is heated with or without adding a conventional Anti-Strip™ additive 102, to between 280 degrees F. and 475 degrees F., and then a powdered SBS polymer 104 is blended in, such as the ‘D1101KG-80’ product, as manufactured by Kraton Polymers of Houston, Tex. The SBS polymer is added at a ratio of approximately between 1% and 10% by weight of the total base binder, optionally combined with a Paraffin 105 at a ratio of between 0.25% and 7% of the total base binder, again by weight, as preferably fed into a standard bitumen type of Mixing-Tank 160, where the above referenced heating 150 is applied to the mixture and it is and blended until homogenous. The term “homogenous” is employed herein to denote a substantial uniformity in observable consistency and flow properties, as typically found acceptable in the pertinent industry for the subject materials, and is consistent when tested by a rotational viscometer.

The resultant Admixture 175 is then allowed to Cool 180 to between 100 degrees F. to 350 degrees F., and at which point a petroleum-based solvent or fuel such as conventional diesel 181, is added at a ratio between 15% and 40% of the total product weight, to form the Binder Product 90.

The terms “approximately” or “approximate” are employed herein throughout, including this detailed description and the attached claims, with the understanding that the terms denote a level of exactness as typical for the skill and precision in the generally applicable field of technology.

Alternatively to the petroleum-based solvent or fuel, referenced as ‘diesel’ 181 in FIG. 1, an Organic Oil 182 may be added to the admixture 175, instead. Specific oils employed as the Organic Oil in the Binder Product 90 may include: canola and corn oil. Other Organic Oils may include other vegetable oils, or animal derived oils or fats. These oils or fats considered for use in the Binder Product include: animal tallow, sunflower, safflower, and peanut oils. However, any readily available animal or vegetable derived oil product or mixture could be employed, either used alone, or in combination with the diesel. Soy bean oil is a preferred Organic Oil used in the Binder Product. Environmentally, organic oils are preferred over the use of petroleum-based solvent or fuel in asphalt products, not only for their biological origins and recyclable use, but also because organic oils typically do not evaporate from the products. Instead they harden through oxidation reactions.

Remarkably, a glycerol may be used as the Organic Oil 182. Glycerol a common name for propane-1,2,3-triol, and is also referred to as glycerine or glycerin. Glycerol is typically produced as a byproduct of bio-diesel manufacture, in the process of “transesterification.” Crude glycerin, as preferably used in an alternative formulation of the present invention, is often thick and dark, with a syrup-like consistency.

Most preferably, the Binder Product 90 is agitated until homogenous, with the Binder Product's end use application temperatures preferably between 70 degrees F. and 350 degrees F., and most preferably between 100 degrees F. and 300 degrees F. The Binder Product may be further processed for immediate use in a Mixed Product 301, as discussed below, or simply containerized ‘as is’ in a Packaged Product 302, or stockpiled at an ambient temperatures to be used on an ‘as needed’ basis, at the ambient temperature. Also alternatively, as shown in FIG. 1, the Mixed Product can be containerized as a Packaged Mix 303.

As shown schematically in FIG. 1, the modified Binder Product 90 can be mixed with the Aggregate 180, as applied to a preestablished aggregate gradation, preferably at a ratio of between 3.0% and 8.0% by weight of total mix. A standard, heated type of drum mixer 300 can be employed in the processing of the Mixed Product 310, for an end use in surface repair and paving. As a less preferred alternative to the Drum Mixer, a conventional batch mixer is considered as an equivalent method of processing the Aggregate with the Binder Product.

Preferably, to prepare the Aggregate 180 for use, a raw aggregate is pre-dried through the Drum Mixer 300 at between 225 degrees F. and 350 degrees F., which is a typical temperature range in processing Hot-Mix Asphalt or “HMA.” The Aggregate is allowed to cool, and then run back through the Drum Mixer at approximately 140 degrees F. to 180 degrees F., and coated with the specified quantity of the modified oil Binder Product 90.

Alternatively, the Aggregate 180 can be processed and coated into the Drum Mixer 300 at higher temperatures, between 150 degrees F. and 350 degrees F., which is more typical of HMA processing, and coated with the modified or alternatively unmodified (neat) Base Binder 100, to between 1% to 2% of total mix weight, in a first pass. The Mixed Product 301 is then allowed to cool to between ambient temperature and 160 degrees F., and then run back through the drum mixer without adding heat, where it is mixed with a final coat of Binder Product, to between 2% and 7% of modified oil Binder Product, by weight of total mix.

A more typical mix ratio of 0.5% to 5%, by weight of Binder Product 90 in the total mix, is most preferred for the Mixed Product 301, for use as an asphalt treated base, with post production handling temperatures for the Mixed Product preferably between 70 degrees F. and 300 degrees F., and most preferably between 60 degrees F. and 100 degrees F.

Preferably, the relative oil content of the Mixed Product 301 or the Binder Product 90 are established using the applicable Federal, State or local methods for asphalt and/or asphalt treated base. Additionally, the finished cold-mix and the asphalt treated base products can be placed and compacted by hand, or with the aid of conventional equipment.

Furthermore, the Binder Product 90 and related end-products are observed to comply with all standards as tested, employing testing methods, gradations and value specifications per the recognized standards employed by the California Department of Transportation “Cal-Trans.” When the optimum or ‘best fit’ formulation is applied to federal, state, or locally specified gradations, the applicable Federal, State or local requirements for HMA as applicable for low to high traffic roads, are achievable by the above described formulations. These specifications may include strength and stability, flow, and ‘voids total mix,’ as required.

When the Binder Product 90 formulations utilizing the Organic Oil 182 are applied to Federal, State or locally specified gradations, it was observed that the Product will meet the applicable Federal, State or local requirements for Hot-Mix Asphalt for stability, flow, and voids total mix when applicable, while substantially reducing environmental impact. Additionally, the above described product formulations can also be used to produce the asphalt treated base for the Binder Product 90. When the Binder Product is mixed with specific aggregate gradations in the Mixed Product 301, it can meet or exceed federal, state and local specifications for HMA and for asphalt treated base. The Binder Product remains pliable and ready for use for months or years, when in the packaged Product 302 form, or simply stockpiled.

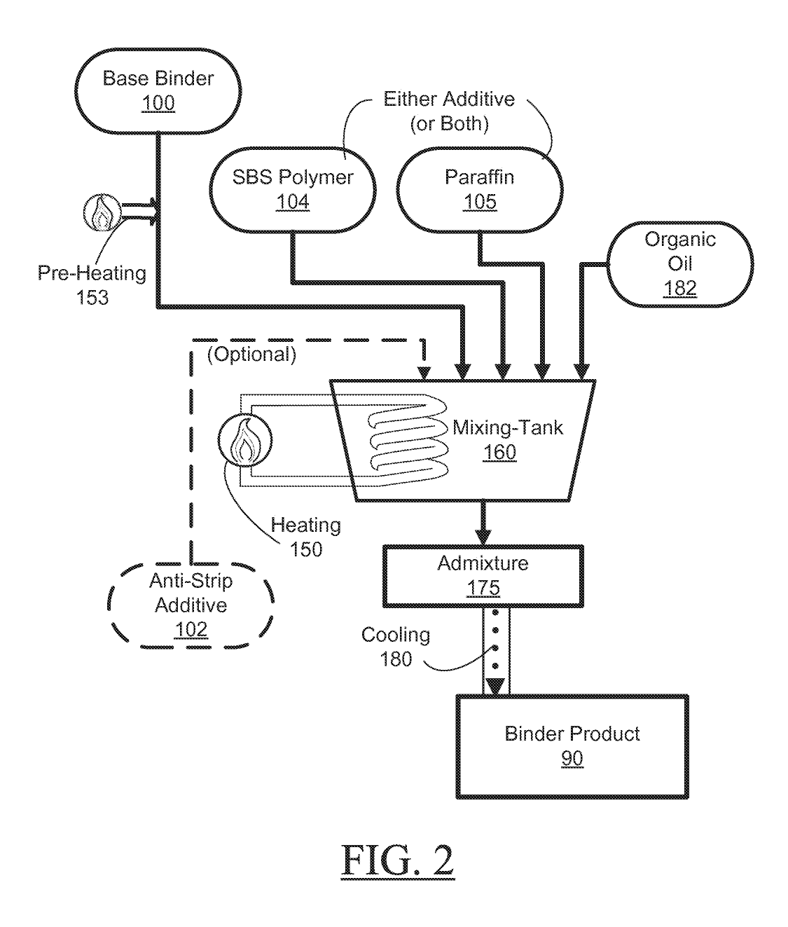

As shown in FIG. 2, in a preferred alternative to the processes for producing the Binder Product 90 described above, the Binder Product may be produced by first heating the Organic Oil 182, to between 250 degrees F. and 400 degrees F. This may be accomplished in the Mixing-Tank 160. Alternatively, the Organic Oil can be pre-heated before transferring into the Mixing-Tank. The SBS Polymer 104 and/or the Paraffin 105 are then both or selectively added to the Organic Oil and blended until homogenous. The interim product can then be added to either the appropriate amount of a Base binder 100, or the Base Binder may be added to the interim product. To best blend with the interim product, the Base binder should undergo a Pre-Heating 153, to between 250 degrees F. and 350 degrees F. The Admixture 175 should be mixed within the Mixing-Tank at between 250 degrees F. and 350 degrees F., with the end-use, or application temperature of the Binder Product 90 preferably between 70 degrees F. and 350 degrees F., and most preferably between 100 degrees F. and 300 degrees F.

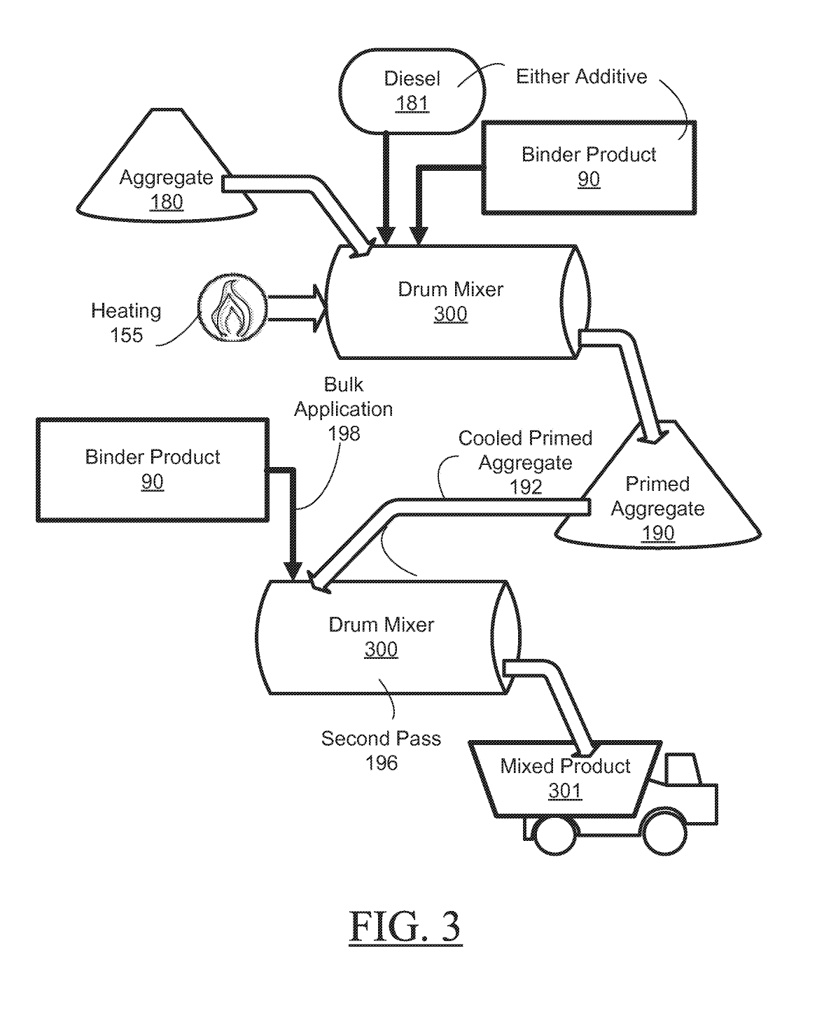

As shown in FIG. 3, in a preferred alternative to the processes for producing the Mixed Product 301, the Aggregate 180 is first dried and heated, preferably by a Heating 155 within the Drum Mixer 300, to between 150 degrees F. and 350 degrees, at which time the Aggregate is primed with preferably the Binder Product 90, or alternatively the Base Binder 100, or alternatively the Diesel 181, preferably at a rate of approximately 0.5% to 3% of the mixture, by weight. The resultant Primed Aggregate 190 is then allowed to cool to between ambient temperature to 250 degrees F., to form a Cooled Primed Aggregate 192. The Cooled Primed Aggregate can then be run back through the Drum Mixer 300, in a Second Pass 196, preferably with no additional heat added, and with the remaining quantity of Binder Product 90 added in a Bulk Application 198, to form the desired Mixed Product 301 formulation, as discussed above.

### A First Preferred Alternative Optimum Formulation and Production Ratios and Ranges:

1) Heat the asphalt Base Binder (PG 64-22), to 350 degrees F.
2) Add approximately 3% of the powdered SBS Polymer, (the Kraton Polymers' D1101KG-80 product), and approximately 0.5% of the Paraffin (Sasobit™), each percentage by weight of total resultant Admixture.
3) Blend the Admixture until homogenous, continuously heating at approximately 350 degrees F.
4) Allow Admixture to cool to 290 degrees F., then mix in 28% diesel fuel, by weight of total Binder Product.
5) In the Drum Mixer, initially blend the Aggregate with 1.5% asphalt base binder (PG 64-22) at 290 degrees F. The binder prepared Aggregate is then allowed to cool to below 150 degrees F., and then recycled back through the Drum Mixer, preferably with no additional heat applied. Generally, for the Cold-Mix Product, 4.5% weight of Binder Product by weight of total mix, will then be added as a finish coat. For an asphalt treated base Mixed Product, 1.5% Binder Product by weight of total mix will be applied, with the Binder Product temperature preferably between 180 degrees F. to 300 degrees F., and most preferably between 200 degrees F. to 260 degrees F.

### A Second Preferred Alternative Optimum Formulation and Production Ratios and Ranges:

1) Heat a quantity of the Organic Oil equaling approximately 30% by weight of the total Binder Product to be produced, to approximately 320 degrees F.
2) In the Mixing-Tank, blend in the SBS Polymer, (most preferably Kraton Polymers' D1101KG-80 product) in an amount that is approximately 3% by weight of total Binder Product 90 to be produced.
3) Mix until homogenous.
4) Add the remaining required Base Binder (67% by total weight of the total Binder Product to be produced), the Base Binder preheated to 250 degrees F., and blend together.

### A Third Preferred Alternative Optimum Formulation and Production Ratios and Ranges:

1) Heat the Aggregate to approximately 250 degrees F.
2) Prime the heated Aggregate by mixing with the Binder Product at approximately 1.5% of the Binder Product by weight of the total mixture.
3) Stockpile the Primed Aggregate, and allowed to cool to 130 degrees F.
4) Run the Cooled Primed Aggregate back through the mixing process, most preferably without additional heating.
5) Add the remaining quantity of Binder Product, as needed, based on desired resultant Mixed Product formulation and specifications.

### A Fourth Preferred Alternative Optimum Formulation and Production Ratios and Ranges:

1) Heat Aggregate to between 200 degrees F. and 300 degrees F.
2) Coat the heated Aggregate by mixing with Binder Product at approximately 4% to 6.5% of the Binder Product by weight of the total Mixed Product.

### Cold-Mix Product Definitions

The following terms and definition relate to bituminous and asphaltic materials for roads and pavements, with industry standard terms and conventions useful for the products and processes of the present disclosure, as commonly used by persons skilled in this area of technology:

“Flux Oil” is an asphalt that is blended typically with gas engine oils to enhance in place low-temperature characteristics.

“Maintenance Mix” is a mixture of bituminous material and mineral aggregate applied at ambient temperature for use in patching holes, depressions, and distress areas in existing pavement using appropriate hand or mechanical methods in placing and compacting the mix. These mixes may be designed for immediate use or for use out of a stockpile at a later time without further processing.

“Plant Mix, Cold Laid” is a mixture of cut-back asphalt, bituminous emulsion, or tar and mineral aggregate prepared in a central bituminous mixing plant and spread and compacted at the job site at or near ambient temperature.

“Workability” in the field of asphaltic products is broadly defined as a property that describes the ease with which an asphaltic product can be laid or placed, worked by hand, and compacted. This definition provides a term that is applicable to a movement or flow of the asphaltic product through equipment to the roadway, hand working of the asphaltic product, and its compact-ability on a roadway or other surface.

More technically, workability is defined as the inverse of the torque required to rotate a test paddle within the sample of the asphaltic product, as conventionally measured as dynamic viscosity in pounds per foot-second, or centipoise, or newton-second per square meter of force. The workability of a particular asphaltic product is affected by properties of the aggregate used in the product mix. One important property of the aggregate is the nominal maximum aggregate size (NMAS) of the gradation. As NMAS increases for a given aggregate gradation and binder type, workability decreases. Additionally, the binder type selected significantly affects the workability of an asphalt product mix, and for HMA there is a definite and unchangeable relationship between workability and temperature, with increased workability at a higher temperature of the asphaltic product.

“Ambient Temperature” is defined as the temperature of a surrounding environment, and more typically referring to the temperature of the air in an outdoor environment. For the purposes of this disclosure, ambient temperature is considered to be between 40 degrees C. (104 degrees F.), and −10 degrees C. (14 degrees F.).

“Polymer Modified Asphalt” (PMA) is binder product generally used in “hot-mix hot-laid,” industrial plant produced mixtures. These Hot Laid products must be combined with crushed aggregate at high temperatures, and preserved at hot temperatures up to their application, placement or laying.

“Extended Asphalt” is a base asphalt combined with added petroleum or organic oils, added to “soften” or decrease the viscosity of the base binders in HMA, (hot-mixed hot-laid asphalts), and which also serve to help the cooled, in-place asphalt to resist cracking in cold temperatures.

“Cut-back Asphalt” is Asphalt cement that has been liquified, typically by blending with petroleum solvents. Upon exposure to atmospheric conditions, the solvents evaporate, leaving the asphalt cement to perform its function. Importantly of note, there are no current test methods or standard evaluation procedures for an asphaltic binder that is cut-back with the Organic Oils of the present disclosure, including vegetable oils and tallows.

In contrast to cut-back asphalt and extended asphalt, “Emulsified Asphalt” is defined as an emulsion of asphalt cement and water that contains a small amount of an emulsifying agent, resulting in a heterogeneous system containing two normally immiscible phases (asphalt and water), in which the water forms the continuous phase of the emulsion and minute globules of asphalt form the discontinuous phase. Emulsified asphalts may be either anionic, electro-negatively-charged asphalt globules or cationic, electro-positively-charged asphalt globules, depending upon the emulsifying agent.

Where emulsions in asphalt cure, or ‘break’ the product, and conventional petroleum based cut-backs in asphalt cure, or ‘set,’ the product, the Organic Oils 182 of the present formulations are cut-backs that rely on oxidation reactions to accomplish the set, which clearly distinguishes its use from the conventional, petroleum based cut-backs.

Standard Product Tests Employed with HMA

Most standard product tests employed with HMA are established by the American Association of State Highway and Transportation Officials (AASHTO), and include:

a. T-53: Ring & Ball Softening Point. For example, this test is typically used to determine the lowest temperature the binder must reach to become fluid enough to pump or transfer from one tank to another. It is also used to determine how much higher the softening point reaches after addition of polymers or other additives for in-place service considerations in regions that reach unusually high ambient temperatures. The test is performed on a disc of solidified binder starting at 41 degrees F. (+/−2 degrees), with the temperature gradually raised in a flask at 9 degrees F. per minute. Remarkably, the Binder Product 90 of the present disclosure is fluid at this starting temperature and in fact the Binder Product never truly solidifies, by design, therefore rendering the Binder Product of the present invention incapable of testing by this method.

b. T-49: Penetration of Bituminous Materials.

c. T-179: Effect of Heat and Air on Asphalt (Materials Rolling Thin Film Oven).

d. T-240: Effect of Heat and Air on a moving film of Asphalt (RTFO).

e. T-313 or TP1-93: Determining the Flexural Creep Stiffness of Asphalt Binder, Using Bending Beam Rheometer (BBR).

f. TP-5: Determining the Rheological Properties of Asphalt Binder Using Dynamic Shear Rheometer (DSR).

g. MP-1: SHRP SUPERPAVE Resistance to Rutting (HMA).

Of note, none of the above tests can be performed on the Mixed Product 300, with the exception of the Resistance to Rutting test (MP-1). The Resistance to Rutting test is a test on a finished asphalt product as apposed to the others listed above, which are strictly binder tests. Importantly, the MP-1 test typically would never be performed on conventional cold-mix products, though with the Mixed Product 301 formulations of the present disclosure, this test and other finished product tests, like the “Hveem Test” (AASHTO T 246: Resistance to Deformation and Cohesion of Bituminous Mixtures by Means of Hveem Apparatus, and AASHTO T 247: Preparation of Test Specimens of Bituminous Mixtures by Means of the California Kneading Compactor), and the “Marshall Test” (ASTM D6927: Standard Test Method for Marshall Stability and Flow of Bituminous Mixtures), can be performed on the Mixed Product, if desired, and especially to demonstrate this Mixed Product 301 formulation can meet the industry standard specifications for finished products, in place.

### Hot-Mix Versus Cold-Mix

The Asphalt Institute is an international trade association of petroleum asphalt producers, manufacturers and affiliated businesses. The Asphalt Institute's manual on “Superpave” regarding the low temperature behavior of asphaltic road materials states that even though asphalt cement is an elastic solid at low temperatures, it may become to brittle and crack when excessively loaded. It is for that reason that hot-mix producers often “extend” their oil. It helps the hot-mix types of binder perform in cooler temperatures. This does not mean that the resulting hot-mix product can be at low ambient or cold temperatures when placed, as the Mixed Product 301 of the present disclosure is able to be placed at, as discussed herein. Conventional HMA products extend the mixtures specifically to reduce cracking and brittleness after placement. These extended hot-mix asphalts must still be mixed and placed within typical hot-mix and hot-placed temperatures typically between 275 degrees F. to 320 degrees F., whereas the target final mixing temperature of the Mixed Product of the present disclosure is 100 degrees F. to 130 degrees F., and can be placed at any typical ambient temperature.

### CMA Gradation Product Improvements

A majority of Cold-Mix Asphalt “CMA” products use an Open Graded gradation of size in the aggregate employed to formulate the CMA product. “Open Graded” refers to a size gradation that contains only a small percentage of aggregate particles in the smaller or “fines” range.

Because of the relative absence of voids in an aggregate mix that includes the fines fraction along with larger crushed gravel, a full size range of aggregate gradation is often referred to a “Dense-Grade” gradation, due to the relative dense packed appearance of the graded material.

Conventionally, a Dense-Graded mix of aggregate is a well-graded HMA mixture intended for general use. When properly designed and constructed, a dense-graded mix is relatively impermeable, especially when compared to an open-graded mix. Dense-graded mixes are generally referred to by their nominal maximum aggregate size. They can further be classified as either fine-graded or coarse-graded. Fine-graded mixes have more fine and sand sized particles than coarse-graded mixes.

This is a purposeful gradation selection, in that the absence of fines in the conventional CMA product results in more void spaces or air voids between the particles of the mineral or rock aggregate in the compacted CMA product. This void space is referred to as “Voids in the Total Mix” (VTM), and specifically defined as the percentage ratio of the volume of voids in a compacted mixture, to the total compacted mixture volume.

HMA testing standards are based on the principle that the VMA in aggregates employed in paving asphalt must be sufficient to allow adequate effective asphalt coverage of the aggregate and include air voids. Open-Graded aggregate is often specified and required in asphalt product manufacturing standards, because the open grade classification of aggregate serves to eliminate small particles that would fill in the voids between the larger aggregate particles. If fines are introduced into conventional asphaltic mixtures, the VMA quickly disappears.

Conventional CMA products use the Open-Graded aggregate for several established reasons, with pliability of the product being foremost. The binders in conventional CMA products do not perform well with the Dense-Graded gradation, because the dense and compact material hardens or sets-up too quickly, making the asphaltic end-product un-useable in a very short period of time, typically within days of manufacture, if left exposed. Conversely, for certain conventional formulations, the fines are deemed to push apart the larger aggregate particles, or allow separations to form between the larger sized aggregate particles, referred to as product “ravel,” or “break away.”

Asphaltic products with Open-Graded aggregate allow moisture to flow through and out of the applied asphaltic product, especially when the product is placed in a porthole, or other depression or material failure, often filled with water. Unfortunately, the use of Open-Graded aggregate has a negative and counter productive effect of allowing moisture to penetrate back through the asphaltic product, which instead serves to deteriorate the base material, and so serves to perpetuate and accelerate the spread of failure in the surrounding material.

However, an asphaltic product with the Dense-Graded aggregate gradation would be relatively impermeable to water, especially when infused with asphalt, and have the potential of displacing any existing water when placed in potholes filled with water, and so displace and prevent moisture from penetrating the patched area, thus eliminating any further deteriorating moisture from seeping into the surrounding area of material.

For the present improved formulations, it was realized that if a CMA product could be perfected employing the Dense-Graded aggregate gradation instead of the Open-Graded aggregate gradation, an improved CMA might be obtained. However, the undesirable issues of quick set-up, and the above discussed problems of loss of void space in the material, and product ravel or break away issues with conventional CMA formulations, must be overcome with any usable Dense Graded CMA formulation. These problems are minimized or solved in the improved “Dense-Graded CMA Product” 400, formulated as disclosed herein.

Typically, a Dense-Graded asphaltic hot-temperature type of product mix is a well-graded HMA mixture, mixed at a hot temperature and intended for general use at the hot temperature when placed or laid. When properly designed and constructed, a Dense-Graded mix is relatively impermeable. Dense-Graded mixes are classified generally by their nominal maximum aggregate size (LAMAS). They can further be referred to as either fine-graded or coarse-graded. Fine-graded mixes have more fine and sand sized particles than coarse-graded mixes. For instance, ‘crushed stone’ is material in the 1″ to ⅜″ sizing, and ‘gravel’ is sized between the #4 through the #50 standard sieves, and ‘sand’ or ‘mineral filler’ typically passes through the #16 up to the #200 standard sieve. TABLE 1, below defines these finely graded and coarsely graded mixes. Dense-Graded mixes are finely graded, typically suitable for all pavement layers and for all traffic conditions. They often work well for conventional structural, ‘friction,’ leveling and patching needs or applications.

TABLE 1
Fine-Graded and Coarse-Graded Definitions for HMA

| Mixture | | |
|---|---|---|
| NMAS | Coarse-Graded Mix | Fine-Graded Mix |
| 37.5 mm | <35% passing the 4.75 mm | >35% passing the 4.75 mm |
| (1.5 inches) | (No. 4 Sieve) | (No. 4 Sieve) |
| 25.0 mm | <40% passing the 4.75 mm | >40% passing the 4.75 mm |
| (1.0 inch) | (No. 4 Sieve) | (No. 4 Sieve) |
| 19.0 mm | <35% passing the 2.36 mm | >35% passing the 2.36 mm |
| (0.75 inches) | (No. 8 Sieve) | (No. 8 Sieve) |
| 12.5 mm | <40% passing the 2.36 mm | >40% passing the 2.36 mm |
| (0.5 inches) | (No. 8 Sieve) | (No. 8 Sieve) |
| 9.5 mm | <45% passing the 2.36 mm | >45% passing the 2.36 mm |
| (0.375 inches) | (No. 8 Sieve) | (No. 8 Sieve) |

The Binder Product 90, for use in the manufacture of the Mixed Product 301 of the present invention is an ideal binder for use in the improved Dense-Graded CMA Product 400 formulation, and is designed to work well with a Dense-Graded aggregate 405, as defined above, and performs well to help seal the edges of repaired areas. With the Dense-Graded CMA Product formulation, the modified Base Binder 100 and very fine material together “finger” or spread-out over the edges of a patch, effectively sealing the repaired area. By using the Dense-Graded aggregate gradation along with the improved Binder Product, much greater workability, including stability, strength and better flow, with superior resistance to deformation is achieved, when compared to conventional CMA mixes. Importantly, these superior properties of the Dense-Graded CMA Asphalt Product are achieved any ambient temperature for the Dense-Graded CMA Asphalt Product, when it is applied, placed or laid.

As discussed above, the void space in the total mix or “VTM,” can describe an important property of a HMA material, and can also be employed to test and described the Dense-Graded CMA Product 400. VTM can be calculated in a sample of asphaltic mix by determining the bulk specific gravity of a lab-compacted briquette under the standard guidelines of California Test Method (CTM) 308, Method A. Then, the theoretical maximum specific gravity under standard guidelines of CTM 309 is determined. With this data, a testing engineer is able to calculate the air void content of each specimen using CTM 309 and CTM 367.

The Dense-Graded CMA Product 400, can meet or exceed federal, state and local specifications for HMA, and for an asphalt treated base. For instance, a test of experimental samples of the Dense-Graded CMA Product found that the VTM of the Dense-Graded CMA Product was 3.3%, which meets the CTM standard of between 3% and 5%. Additionally, experimental samples of the Dense-Graded CMA Product employing the “Hveem Test” (AASHTO T 246), as listed above, showed that the samples met the minimum standard of 37, with measured values of 46 and 39.

Remarkably, the Dense-Graded CMA Product 400 of the present disclosure remains pliable, with a long “shelf-life” and is ready for use for months or years, when in the packaged form, or simply stockpiled. Shelf life is the length of time that a commodity may be stored without becoming unfit for use, consumption, or sale. The shelf-life of experimental formulations of Dense-Graded CMA Product has been measured to exceed five years.

The following steps are preferably employed, when placing the Dense-Graded CMA Product 400, as formulated according to the present invention:

### A Lay-Down Procedure for the Dense-Graded CMA Product:

1) Clean edges of area to be repaired. (Where possible, insure at least ¼ inch to ½ inch depth.)
2) Place sufficient material in area to allow for compaction of ¼ inch, per inch of depth.
3) Smooth out with a rake, shovel, screed board or by hand.
4) Compact with conventional tools, including a Vibra Plate™ brand of compactor, a wheel-roll with a vehicle tire, or a placement of a board over the asphalt with the wheel-roll, or by employing a standing pressure.

A preferred Dense-Graded CMA Asphalt Product 400, formulated according to the present invention, is listed as “X” in TABLE 2, below. The Dense-Graded CMA Asphalt Product exhibits a significantly different grade profile, as compared with the Open-Graded aggregate 409 of the three commercially available prior-art cold-mix products 410, listed as “A,” “B” and “C.”

TABLE 2
MODIFIED DENSE-GRADED ASPHALT PRODUCT
AS COMPARED TO THREE COMMERCIALLY
AVAILABLE CMA PRODUCTS:

| Sieve Sizes | Band | X | A | B | C |
|---|---|---|---|---|---|
| 1″ | 95-100 | 100 | 100 | 100 | 100 |
| ¾″ | 90-100 | 100 | 100 | 100 | 100 |
| ½″ | 80-100 | 95 | 100 | 99.6 | 100 |
| ⅜″ | 60-100 | 85 | 100 | 98.6 | 100 |
| #4 | 40-75 | 55 | 20-85 | 86.8 | 93.3 |
| #8 | 25-45 | 40 | 2-30 | 59.2 | 23 |
| #16 | 20-40 | 30 | 0-10 | 15.4 | 4.7 |
| #30 | 12-35 | 25 | N/A | 7.5 | N/A |
| #50 | 9-35 | 15 | 0-6 | 4.5 | 2.7 |
| #100 | 5-15 | 10 | N/A | 2.9 | N/A |
| #200 | 0-10 | 5.0 | 0-2 | 2.6 | 2.7 |

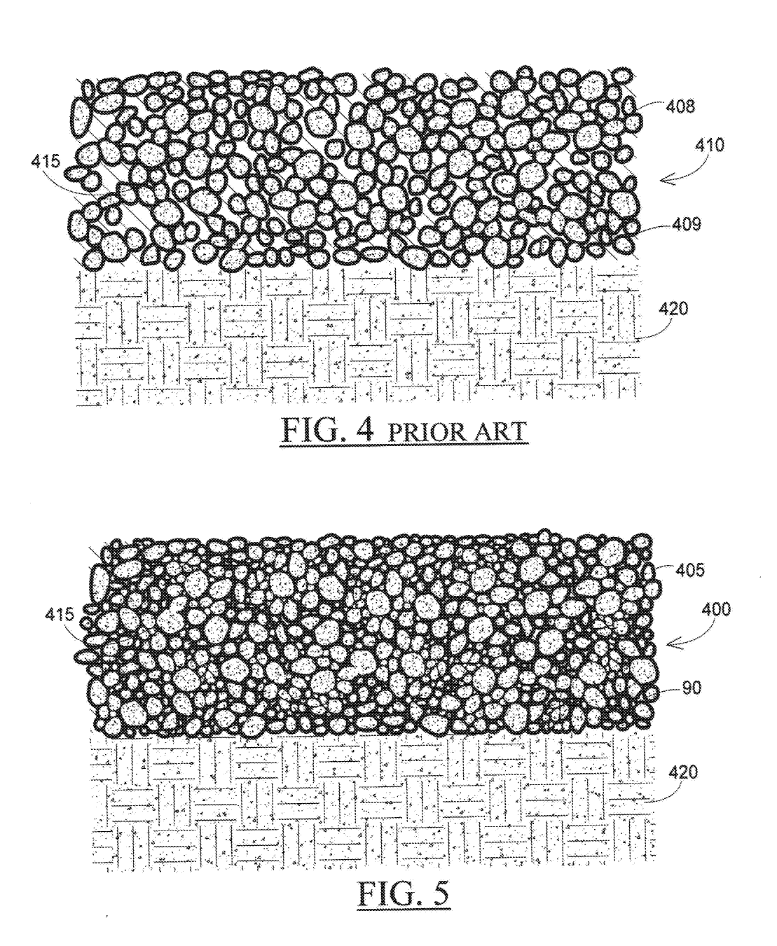

When placed, the Dense-Graded CMA Asphalt Product 400 looks and preforms much differently than the conventional Open-Graded aggregate 409 products. FIG. 4 shows a typical prior-art cold-mix product 410, compared to the improved Dense-Graded CMA Asphalt Product shown in FIG. 5. The prior-art formulation of FIG. 4 represents any one of the “A,” “B” or “C” products listed in TABLE 2, without appreciable quantities of material between standard sieve sizes #16 and #200, conventionally referred to “mineral filler.”

Additionally, a void space 415 is present in the prior-art cold-mix product 410, as shown in FIG. 4, and can also be seen in the Dense-Graded CMA Product 400, as shown in FIG. 5. Interestingly, the void spaces in the prior-art cold-mix product tend to be larger in volume, but fewer in number, when compared to the void spaces in the Dense-Graded CMA Product.

The Dense-Graded CMA Product 400 of the present invention employs the mineral filler of fine gradation in conjunction with the Binder Product to insure a waterproof seal, which protects and adheres to the base material 420, keeping the base material strong and in place. The vast majority of other cold placed asphalt materials use only the coarse sized gravel, as listed in TABLE 2, above. Besides being referred to an Open-Graded, this type of coarse gradation is called “porous-grading.” Because it is the only way to give conventional products the needed workability, porous-graded aggregate is required in the prior-art cold-mix product 410, as shown in FIG. 4. This is because of the inferior nature of the prior cut-back binders. These conventional cut-back binder materials assure deformation, degradation and eventual failure of a repaired area, because they allow water to seep through to the base material.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

The following is claimed:

1. A method for formulating a cut-back binder product for mixing with an aggregate, to produce a cold-mix asphalt product, the method comprising the steps of:
a) heating an asphalt base binder;
b) adding a SBS polymer, to form an admixture;
c) blending the admixture until substantially homogenous;
d) cooling the admixture;
e) mixing the admixture with an organic oil to form the cut-back binder product;
f) coating a dense-graded aggregate with the cut-back binder product; and
g) forming a dense-graded cold-mix asphalt product with the cut-back binder product and the dense-graded aggregate, the dense-graded cold-mix asphalt product pliable and ready for use after storage at an ambient temperature.

2. The method for formulating the cold-mix asphalt product of claim 1, wherein the organic oil mixed into the admixture is approximately 15% to 40%, by weight of the total cut-back binder product.

3. The method for formulating the cold-mix asphalt product of claim 1, wherein the organic oil is an animal derived oil.

4. The method for formulating the cold-mix asphalt product of claim 1, wherein the organic oil is a vegetable derived oil.

5. The method for formulating the cold-mix asphalt product of claim 1, wherein the organic oil is a glycerol.

6. The method for formulating the cold-mix asphalt product of claim 5, additionally including the step of:
h) priming the dense-graded aggregate with approximately 0.5% to 5% by weight of the cut-back binder product by weight of the total cold-mix asphalt product, prior to adding the cut-back binder product to the dense-graded aggregate.

7. The method for formulating the cold-mix asphalt product of claim 6, additionally including the step of:
i) cooling the dense-graded aggregate after priming, before adding the cut-back binder product to the dense-graded aggregate.

8. The method for formulating the cold-mix asphalt product of claim 8, wherein the cut-back binder product is blended with the dense-graded aggregate without additional heating.

9. A method for formulating a dense-graded cold-mix asphalt product, the method comprising the steps of:
a) heating an asphalt base binder;
b) mixing in an organic oil to form an admixture;
c) cooling the admixture to form a cooled admixture; and
d) blending the cooled admixture with a dense-graded aggregate to form the dense-graded cold-mix asphalt product, the dense-graded cold-mix asphalt product stable and pliable at an ambient temperature.

10. The method for formulating the dense-graded cold-mix asphalt product of claim 9, wherein the organic oil mixed into the admixture is approximately 15% to 40%, by weight of the total admixture.

11. The method for formulating the dense-graded cold-mix asphalt product of claim 9, wherein the organic oil is an animal derived oil.

12. The method for formulating the dense-graded cold-mix asphalt product of claim 9, wherein the organic oil is a vegetable derived oil.

13. The method for formulating the dense-graded cold-mix asphalt product of claim 9, wherein the organic oil is a glycerol.

14. The method for formulating the dense-graded cold-mix asphalt product of claim 9, additionally including the steps of:
e) adding a SBS polymer to the asphalt base binder to form the admixture, prior to blending the cooled admixture with the dense-graded aggregate; and
f) blending the admixture with a vegetable oil prior to blending the cooled admixture with the dense-graded aggregate.

16. The method for formulating the dense-graded cold-mix asphalt product of claim 9, additionally including the steps of:
e) adding a SBS polymer to the asphalt base binder to form the admixture, prior to blending the cooled admixture with the dense-graded aggregate; and
f) blending the admixture with a diesel oil prior to blending the cooled admixture with the dense-graded aggregate.

17. The method for formulating the dense-graded cold-mix asphalt product of claim 16, additionally including the step of:
g) adding a paraffin to the asphalt base binder.

18. A dense-graded cold-mix asphalt product comprising:
a heated asphalt base binder combined with a SBS polymer, to form an admixture, and the admixture blended until substantially homogenous;
the admixture cooled and mixed with an organic oil to form a cut-back binder product;
the ‘cut-back’ binder product combined with a dense-graded aggregate to form the dense-graded cold-mix asphalt product; and
the dense-graded cold-mix asphalt product applied at an ambient temperature.

19. The dense-graded cold-mix asphalt product of claim 18, wherein:
the dense-graded aggregate is primed with approximately 0.5% to 5% by weight of the cut-back binder product by weight of the total dense-graded cold-mix asphalt product, prior to adding the cut-back binder product to the dense-graded aggregate, to form the dense-graded cold-mix asphalt product.

20. The dense-graded cold-mix asphalt product of claim 18, wherein the cut-back binder product is blended with the dense-graded aggregate without additional heating of the dense-graded cold-mix asphalt product.
